(19) United States
(12) Patent Application Publication
(10) Pub. No.: US 2019/0140848 A1
(43) Pub. Date: May 9, 2019

(54) Decentralized Access Control for Cloud Services

(71) Applicant: Spinbackup Inc., San Francisco, CA (US)

(72) Inventors: Dumitru Dontov, Burlingame, CA (US); Mykola Klymenko, Burlingame, CA (US)

(73) Assignee: Spinbackup Inc., San Francisco, CA (US)

(21) Appl. No.: 16/183,575

(22) Filed: Nov. 7, 2018

Related U.S. Application Data
(60) Provisional application No. 62/582,557, filed on Nov. 7, 2017.

(51) Int. Cl. H04L 9/32; G06F 17/30; H04L 9/06; H04L 29/06

(52) U.S. Cl. CPC H04L 9/3268; G06F 17/30283; H04L 2209/38; H04L 63/0823; H04L 9/0643; H04L 9/0637

(57) ABSTRACT

A decentralized system for issuing digital certificates to users and authenticating such users is provided. A certificate issuer system may verify a user and issue a digital certificate to the user. The certificate issuer system may also calculate authenticity information relating to the digital certificate and cause the same to be recorded in a distributed ledger system, for example, in the form of a smart contract. When the user attempts to access a cloud application, the application receives the digital certificate, calculates second authenticity information relating to the certificate, and compares the calculated authenticity information to that recorded in the distributed ledger system. Upon a determination that the calculated and recorded authenticity information match, an authentication confirmation may be generated and the user may be permitted to access the cloud application.

### CROSS-REFERENCE TO RELATED APPLICATIONS

The present application claims the benefit of U.S. Provisional Patent Application No. 62/582,557, titled “Blockchain Single Sign-on for Cloud Services” filed Nov. 7, 2017, and U.S. Provisional Patent Application No. 62/722,652 titled “Blockchain Single Sign-on for Cloud Services” filed Aug. 24, 2018. Each of the above applications is incorporated by reference herein in its entirety.

### BACKGROUND

This specification relates to network security applications and, more specifically, to applications that employ distributed ledger functionality to facilitate a user's secure login to any number of cloud services.

Data stored in cloud-based systems and applications has become a primary target for cyber criminals. The traditional password-based security protocols employed by most cloud services no longer guarantee protection of user data. In the 2017 Equifax data breach, for example, hackers exploited weak administrator passwords to steal the personal information of more than 143 million Americans. Because hackers and other cyber criminals continue to improve their phishing and malware attacks to obtain passwords, cloud services have responded by forcing users to set increasingly complex passwords that are difficult to remember. As a result, users often resort to using a universal password or scheme for many different cloud services, which drastically compromises security.

Single sign-on (“SSO”) processes provide a more-secure way for cloud systems to control user access to sensitive data. Generally, SSO may employ digital certificates, or data files that associate a given identity (e.g., a name, a username, an email address, etc.) with a specific public key for use in a public key infrastructure (“PKI”). Digital certificates allow others (relying parties) to rely upon signatures and other assertions made by a private key that corresponds to the public key associated with a given certificate.

Traditionally, certificate authorities (“CAs”) have been responsible for verifying users and issuing digital certificates to verified users. These third parties are trusted by both the owner of a digital certificate (the subject) and the party relying upon the certificate (the relying party). Generally, the CA may verify a subject by requiring the subject to provide some personal identifying information (“PII”) that allows the CA to recognize and identify them. The CA then verifies such PII using their internal flow and algorithms. If the CA is satisfied with the provided PII, they may issue a new digital certificate for that subject.

Although SSO processes are more secure than simple password protection, traditional SSO suffers from a number of drawbacks. Many CAs require subjects to provide official documentation or other proof of certain PII for verification purposes. For example, a CA may require a user to upload and/or mail specific types of documents, such as a social security card, a driver's license, a utility bill and others. Unfortunately, this verification process is inconvenient for a typical internet user and may not work for users located in certain countries (e.g., those that do not issue social security cards).

Moreover, the legitimacy of a given digital certificate is determined by a relying party based on an included digital signature associated with the issuing CA. The digital signature is generated by the CA using a private key (i.e., a root certificate private key) and the authenticity of the signature is verified by a relying party via a public key (i.e., a root certificate public key). Unfortunately, if a hacker steals or forges the CA's root certificate private key, they may be able to falsify digital signatures and issue any number of digital certificates. Indeed, modern computational technologies and cryptanalysis methods have made it possible and practicable to forge root certificates, and cyber security experts are reporting a growing number of root certificates due to hacker attacks.

Accordingly, there exists a need for improved access control systems that allow user's to access multiple cloud services without a password. It would be beneficial if such systems could allow a certificate issuer to verify subjects via any number of existing trusted identity provider systems, such as social media systems and others. It would be further beneficial if such systems employed a decentralized, distributed ledger to publicly and permanently record certificate authenticity information to allow relying parties to determine the authenticity of a given digital certificate, without the need for CA root certificates.

### SUMMARY

In accordance with the foregoing objectives and others, exemplary applications, methods, and systems are disclosed herein provide improved user access control, user authentication and/or SSO for software-as-a-service (SaaS) applications, browser-based web applications, native mobile applications, desktop software and hybrid cloud services (collectively referred to herein as “cloud services” or “cloud applications”).

In one embodiment, a method of issuing a digital certificate is provided. The method may include receiving, by a certificate issuer system, a digital certificate request from a user device associated with a user; receiving, by the certificate issuer system, permission to access user information associated with the user stored in an identity provider system. Upon accessing the identity provider system, the certificate issuer system may receive the user information. The method may further include creating, by the certificate issuer system, a digital certificate associated with certificate information, such as but not limited to identity information selected from the user information, a unique public key, a location associated with a distributed ledger system, and checksum algorithm information specifying a checksum algorithm. The method may also include calculating, by the certificate issuer system, a checksum of the certificate information based on the checksum algorithm; and transmitting, by the certificate issuer system, authenticity information associated with the digital certificate (e.g., the checksum and the public key) to the location to thereby cause the authenticity information to be recorded on the distributed ledger system. Finally, the method may include transmitting, by the certificate issuer system, the digital certificate to the user device to thereby cause the digital certificate to be stored in a memory of the user device.

In another embodiment, an authentication method is provided. The method may include receiving, by a user authentication system, certificate information associated with a digital certificate, wherein the certificate information may include a unique public key and checksum algorithm information specifying a checksum algorithm. The method also includes retrieving, by the user authentication system, authenticity information associated with the digital certificate, wherein the authenticity information may be stored at a location associated with a distributed ledger system, and wherein the authenticity information includes the unique public key and a first checksum. The method further includes calculating, by the user authentication system, a second checksum of the certificate information based on the checksum algorithm; and determining, by the user authentication system, that the first checksum matches the second checksum. The authentication system may then generate an authentication confirmation only upon determining that the first and second checksums match.

In one embodiment, the certificate information may be received from a cloud application and the generated authentication confirmation may be transmitted to the cloud application. For example, the certificate information may be received from the cloud application when the cloud application receives the digital certificate from a user device associated with a user attempting to perform an action relating to the cloud application. Accordingly, transmitting the generated authentication confirmation may cause the cloud application to allow the user to perform the action (e.g., a login action).

In other embodiments, the certificate information may be received from a user device. For example, a user device may transmit a digital certificate including the certificate information when the user device attempts to perform an action relating to the user authentication system. In such cases, generating the authentication confirmation may permit the user device to perform the action.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an exemplary method 100 of issuing digital certificates according to an embodiment.

FIG. 2 shows an exemplary method 200 of providing user access control for a cloud service according to an embodiment.

FIG. 3 shows an exemplary access control system 300 according to an embodiment.

### DETAILED DESCRIPTION

Various applications, methods and systems are disclosed herein to provide improved user access control, user authentication and/or SSO for any number of cloud services. The described embodiments may facilitate digital certificate issuance by enabling certificate issuers to verify subjects via any number of existing identity provider systems. Such embodiments may employ a decentralized, distributed ledger to publicly and permanently record certificate authenticity information. Accordingly, the embodiments disclosed herein allow relying parties to determine the authenticity of a given digital certificate without the need for CA root certificates.

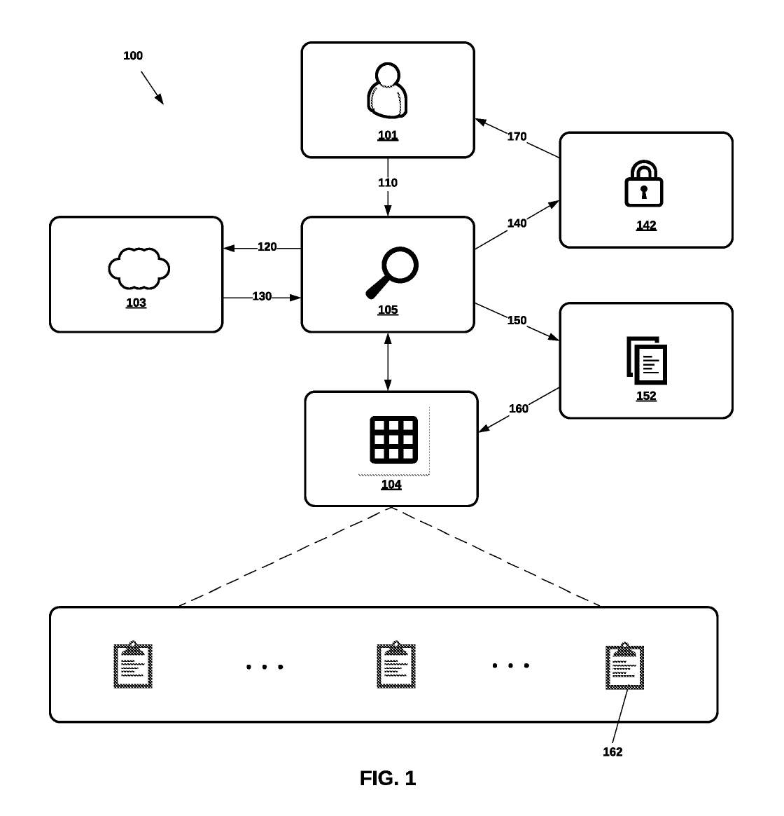

Referring to FIG. 1, an exemplary method 100 of issuing digital certificates is illustrated. As shown, the method begins at step 110, where a certificate issuer system 105 receives a request for a digital certificate from a subject or user 101.

In one embodiment, the certificate issuer 105 receives request information from the user 101 with the digital certificate request, wherein the request information specifies one or more identity provider systems 103 and grants the certificate issuer 105 access to some or all of the user's user information stored in the identity provider system 103.

Generally, an identity provider system 103 comprises a server that can provide user information associated with one or more users to the certificate issuer system 105. Exemplary identity providers 103 include social network systems (e.g., FACEBOOK login, TWITTER login, GOOGLE login, etc.), enterprise systems (MICROSOFT ACTIVE DIRECTORY, GOOGLE G SUITE, AZURE ACTIVE DIRECTORY, LDAP, etc.), legal systems (e.g., CRIIPTO, NEMID, BANKID, etc.) and/or other custom databases. Identity providers may use various authentication protocols, such as OPENID CONNECT, SAML, OAUTH2, WS-FEDERATION and others.

In a step 120, the certificate issuer system 105 accesses the identity provider system 103. In one embodiment, an access token may be required to access the identity provider system. An access token may comprise, for example, an opaque string generated by the identity provider, an application ID, a user ID, one or more permissions, an expiration time, and other data. In such embodiments, a temporary or semi-temporary access token may be issued by the identity provider 103 to the certificate issuer system 105. If access to certain user information is required, such as for digital certificate generation, the user 101 may be prompted to set permissions for data access. Said permissions may be stored in the access token.

It will be appreciated that, in some embodiments, the certificate issuer system 105 may employ an identity provider 103 to authenticate users of the certificate issuer system. For example, a user may navigate to a client application of the certificate issuer system 105, select a social login option to be redirected to a corresponding identity provider's website, login to the identity provider, and then be automatically redirected and signed into the client application. In such embodiments, an access token provided to the certificate issuer system 105 by the identity provider 103 upon user login may also be used to request identity information from the identity provider.

Once the certificate issuer system 105 is connected to the identify provider system 103, it receives identity information from the identity provider system 103, as shown in a step 130. Identity information can include anything stored in the identity provider system 103 (e.g., first name, last name, username, email, gender, age, birthday, profile image, etc.). In a further optional step (not shown), identity information received from a particular identity provider system may be cross-referenced with another identity provider system. Differences may be reconciled by the user 101 and modifications may be propagated to the respective identity provider system(s) 103.

In a further step 140, the certificate issuer system 105 determines certificate information and creates a digital certificate 142 incorporating the certificate information. In one embodiment, the digital certificate employs the X.509 standard (RFC5280), although other standards or infrastructures may be utilized. As explained below, the digital certificate information may comprise: any identity information provided by the identity provider system, a unique public key associated with the user, public key information (e.g., key size, key usage), checksum algorithm information, location information, a unique ID (i.e., a serial number), certificate issuer information (e.g., name, address, etc.), a validity period, and any desired or required additional information.

In a step 150, the certificate issuer system 105 determines authenticity information 152 for the digital certificate 142. Generally, authenticity information 152 is publicly available information that may be used by a relying party to determine the authenticity of a given digital certificate.

In one embodiment, the authenticity information 152 includes a checksum generated by the certificate issuer system via application of a specific checksum algorithm (e.g., SHA-1, SHA-2 (SHA-256, SHA-512), MD5, RIPEMD-160, BLAKE2, WHIRLPOOL or other has functions) to the digital certificate information stored in the digital certificate 142. It will be appreciated that the checksum algorithm information included in the digital certificate information identifies the checksum algorithm used to generate the checksum 152.

The authenticity information 152 may also include other digital certificate information, in addition to the checksum. For example, such information may include the unique public key of the digital certificate 142.

In a further step 160, the certificate issuer system 105 may record the authenticity information 152 to a distributed ledger system 104 (also referred to herein as a blockchain network). Exemplary distributed ledger systems may include, but are not limited to, ETHEREUM, BITCOIN, EXODUS, HYPER LEDGER and many others.

In one embodiment, the issuer system may record the authenticity information 152 by transmitting such information via a transaction to a smart contract 162 (“smart contract transaction”) located on the blockchain network 104. The smart contract 162 may follow the Contract Application Binary Interface (“ABI”) for ETHEREUM, or other contract specifications if other blockchain networks are employed.

The smart contract 162 is associated with location information. In one embodiment, location information comprises a smart contract address deterministically computed from the address of its creator (e.g., the certificate issuer system 105) and the number of transactions sent by the creator (i.e., nonce). This allows the certificate issuer system 105 to incorporate the address into the digital certificate information of the digital certificate 142 in step 140, generate the authenticity information 152 in step 150, and record the authenticity information via transaction the smart contract 162 in step 160 with. In an optional step (not shown) a transaction ID may be generated by the blockchain network 104 and stored as proof of the creation of the smart contract 162 in the certificate issuer system 105. Only when the smart contract 162 is written into the blockchain network 104 can the address be called in an authentication method as described below.

In one embodiment, the location information may include an address to locate a non-smart contract transaction in a particular block of the blockchain. In another embodiment, the authenticity information 152 may be transmitted to a non-smart contract block in a private blockchain network. In yet another embodiment, the authenticity information 152 may be stored in a database (i.e., through a database management system of the user device, a local server, a cloud storage system, or a distributed file storage system).

In a step 170, the digital certificate 142 is transmitted to the user 101 (i.e., a user node). Upon recordation of the smart contract 162 into the blockchain network 104, the certificate issuer system 105 may remove received identity information, the digital certificate 142, and the checksum 152. In this way, the certificate issuer system 105 ensures the privacy of the user 101 by storing sensitive data only at the user node.

Generally, the decentralized architecture provided by blockchain technology, combined with the use of smart contracts, provides the best solution for managing transactions using a decentralized common database which does not involve third parties. Additionally, vast networks of independent nodes, complex cryptographic communication, and group consensus on ledger updates prevent the possibility of falsifying data on transactions that are public by nature and completely open to users—making data immutable and reliable throughout the network. It will be appreciated that falsification or deletion of blockchain information is prevented, in part, through the implementation of consensus algorithms which oblige independent nodes to agree on past transactions before proceeding to incorporate the transactions in the next proposed block.

The safety of digital certificates issued in the above manner is guaranteed by not relying on centrally located root certificates, preventing complex certificate chains, and not needing to depend on the availability of a current certificate revocation list (CRL) to validate certificates. Accordingly, such digital certificates may be employed to provide vastly improved SSO authentication methods and systems.

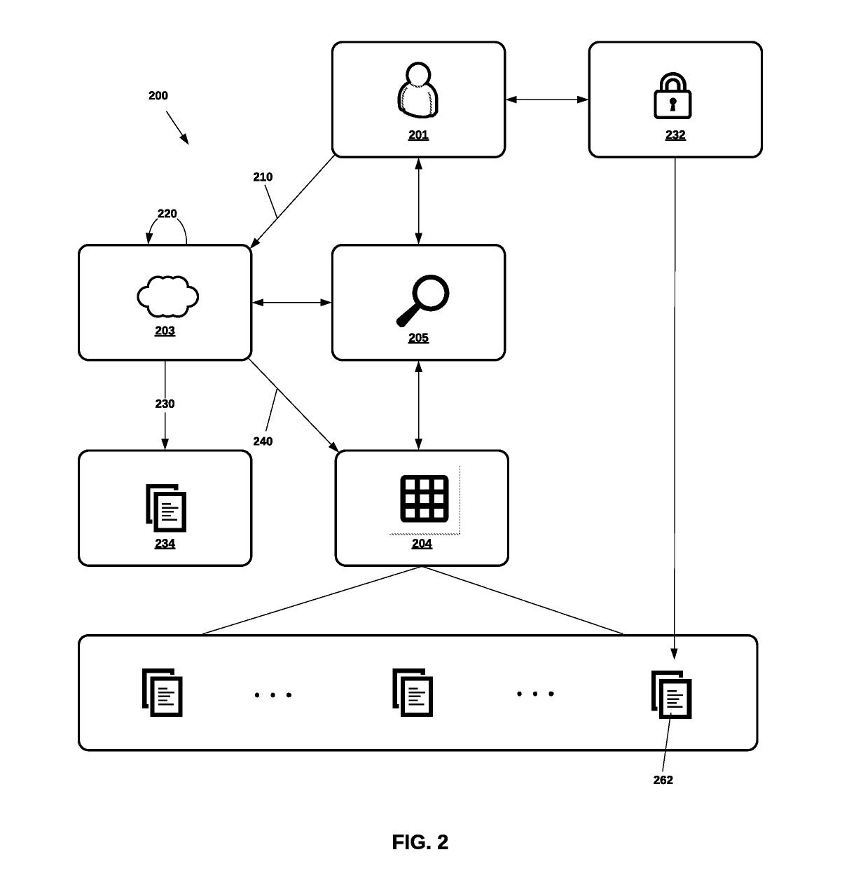

Referring to FIG. 2, an exemplary method 200 of providing user access control for a cloud service is illustrated. In a first step 210, a cloud service 203 receives a digital certificate 232 associated with a user 201. Generally, the received digital certificate 232 may be issued according to the issuance method 100 of FIG. 1 and may comprise the certificate information discussed above.

In one embodiment, the cloud service 203 may receive the digital certificate 232 from a user 201. For example, a user device may transmit a stored digital certificate to the cloud service upon attempting to perform an action associated with the cloud service (e.g., login, access or modify a resource, etc.).

In another embodiment, the cloud service 203 may receive a digital certificate 232 and/or any certificate information associated with the digital certificate from a separate system (a “primary system”). In this case, the primary system may receive the digital certificate 232 from a user device 201 attempting to perform an action associated with the primary system. The primary system may then transmit the digital certificate and/or associated certificate information to the cloud service.

In a step 220, the cloud service 203 reads the certificate information associated with the digital certificate 232 in order to identify the associated checksum algorithm information, smart contract address, and unique public key included therein. In a step 230, the cloud service 203 generates a checksum (i.e., a second checksum 234) of the digital certificate 232 by applying the checksum algorithm identified by the checksum algorithm information. In this way, the cloud application employs the same checksum algorithm that was used by the certificate issuer.

In a step 240, the cloud service 203 may search the blockchain network 204, at the smart contract address defined in the digital certificate 232, to locate the smart contract 262 containing authenticity information relating to the digital certificate. Upon locating the smart contract 262, the cloud service may parse it to find the relevant authenticity information. For example, the cloud service 203 may search the smart contract 262 to locate a public key that corresponds to the public key stored in the digital certificate 232. Once the relevant authenticity information is located in the smart contract 262, the cloud service 203 reads the corresponding first checksum (see FIG. 1 at 152).

The cloud service 203 may then compare the second checksum 234 to the first checksum to determine whether the digital certificate should be authenticated. If the first and second checksums match, the cloud service 203 may generate and/or transmit an authentication confirmation, which may grant the user 201 access or otherwise allow the action attempted by the user. However, if the checksums do not match, the cloud service may generate and/or transmit an error notification, which prevents the user 201 from taking the attempted action.

As an example, in an embodiment where the user is attempting to perform an action associated with the cloud service, such action may be permitted by the cloud service upon generating the authentication confirmation. As another example, in an embodiment where the cloud service receives the digital certificate information from a primary system, the cloud service may transmit the authentication confirmation to the primary system to thereby cause the primary system to permit the user action.

In one embodiment, the cloud service 203 may remove the second checksum 234 and, optionally, the digital certificate 232 from storage after authentication 200 is complete.

It will be appreciated that any number of notifications may be transmitted/received to/from the cloud application throughout the authentication method 200. For example, in one embodiment, the smart contract 262 may execute an instruction stored therein to transmit a false certificate detection alert to the user 202, the cloud service 203, and/or the certificate issuer system 205.

It will also be appreciated that, in some embodiments, additional security mechanisms may be employed to confirm ownership of the digital certificate 232 by the user 201 (i.e., to confirm that the certificate and a private key belong to the same user). For example, in addition to the above-described certificate information, the cloud application may receive a random value signed with a private key provided by the user at the beginning of the authentication process 200. The cloud application may then verify the signature on the received value to confirm digital certificate ownership.

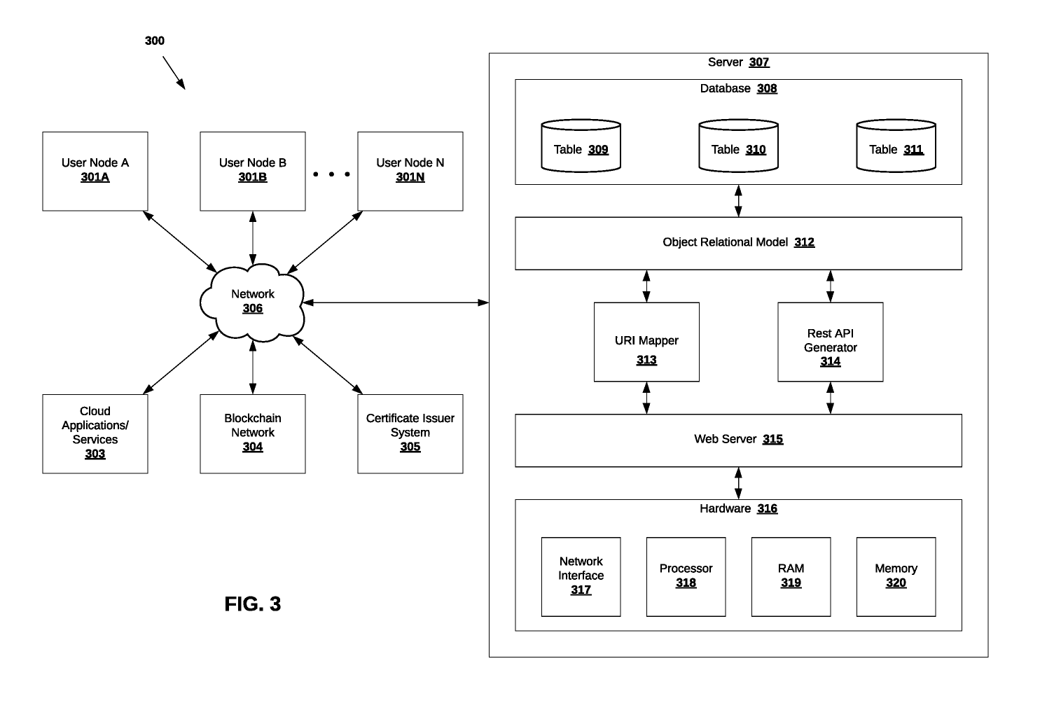

Referring to FIG. 3, an system 300 according to an embodiment is illustrated. As shown, the system 300 comprises any number of user nodes 301A-N capable of accessing cloud services 303, a blockchain network 304, and/or a certificate issuer system 305 through a network 306 (e.g., Internet, local area network, wide area network, cellular, intranet, etc.). The certificate issuer system 305 may, inter alia, perform the certificate issuance method 100 and the user access control method 200 described above. Alternatively, various steps of the above methods 100, 200 may be performed by the certificate issuer system 305 and one or more additional a cloud services 303.

The certificate issuer system 305 utilizes a distributed ledger system (“DLS”) (e.g., the blockchain network 304) in which one or more user nodes 301A-N issue transactions that, in aggregate, change the state of the ledger (i.e., are appended to the ledger) at regular intervals. DLSs generally operate across several nodes (data processing devices, such as a mobile device, laptop, desktop, or server) in a peer-to-peer fashion where each node independently replicates and updates the ledger. In an open DLS, all nodes construct the new state of the ledger based on the transactions in the latest update. The nodes vote for a state of the ledger based on a consensus algorithm and the correct copy of the ledger is propagated, e.g., through a gossip protocol. In a closed DLS system, a specific subset of nodes (“full nodes”) oversees determining consensus when new transactions are issued.

In addition, a DLS may be permissioned or permissionless. A permissionless DLS allow any user to operate a full node to interact with the ledger. A permissioned DLS only allows approved users to operate a full node. Although Blockchain is a particular DLS that is open, distributed, and decentralized, it is only one example of a DLS which may be utilized to facilitate the various embodiments described herein.

It will be appreciated that references to a “user node” may be directed to a node operated by a user, i.e., a device utilized by the user to access cloud services. Thus, a user node implies an underlying identity which may remain anonymous by utilizing the certificate issuer system 305.

In one embodiment, the certificate issuer system 305 may be entirely or partially implemented on one or more servers 307 comprising hardware 316 such as any number of processors 318, random-access memory (“RAM”) 319, and internal or external memory 320. The server 307 may include a network interface 317 such that it may access the network 306 to send or receive information through the network 306.

As shown, at least one database 308 may be accessed by the server 307. Although shown as internal to the server 307, it will be appreciated that the database 308 may be accessed by the server 307 over the network 306 or via another wired or wireless connection. The server 307 may store desired or required information in the database 308 and may access the same to retrieve the information. As shown, the database 308 may include one or more database tables 309-311.

The database 308 may be in communication with an object relational mapping (“ORM”) tool, also known as an object relational model 312 or object-relational database management system. Although shown as internal to the server 307, it will be appreciated that the ORM 312 may be accessed by the server over the network 306 or via physical connection.

The ORM 312 may be in communication with one or more of the following: a Universal Resource Indicator (URI) mapper 313, and a Rest API generator 314. First, the URI mapper 313 may map a URI into a pointer to an internal program, view, logic, or presentation of data within the system, based on one or more rules of a matching object specified in a collection of mapping objects. The matching object may be a regular expression. The URI mapper 313 may be in communication with a web server.

The Rest API generator 314 may be in communication with a web server to send and/or receive data to/from client devices communicating with the server using HTTP and/or HTTPS. The Rest API generator 314 may prepare data stored in the database 308 for delivery to a client device, may receive data from connected systems and/or may prepare data received from for storage or transmission to one or more connected systems. The Rest API 314 may be capable of translating between formats including, but not limited to JSON, XML, CSV, and the like. The Rest API generator 314 may be capable of automatically generating URIs based upon data structures observed in the ORM 312 for access by client devices and connected systems.

A web server 315 may be adapted to deliver web pages on request to user nodes using the Hypertext Transfer Protocol (HTTP and/or HTTPS) or similar protocols. This allows for delivery of HTML documents and any additional content that may be included by a document, such as images, style sheets and scripts.

A user node 301A-N may employ a web browser or similar client application to engage in communication with a web server. For example, a client application may make a request for a specific resource using HTTP/HTTPS and the web server may respond with the content of that resource or an error message if unable to do so. The resource may be data or a file stored in a database. The web server can receive content from a user node, possibly using HTTP/HTTPS.

In certain embodiments, a user node 301A-N may access the server 307 (i.e., an application running on the server) through a network 306. The user node may be capable of running a client application or other software, like a web browser or web-browser-like application. In one embodiment, the user node 301A-N may comprise, for example, an input/output device, a display, a processor, memory, and/or audio equipment. Exemplary user nodes include, but are not limited to, general purpose computers, laptops, cell phones, smartphones, personal digital assistants, televisions, tablets, wearable devices and the like.

An exemplary certificate issuer and authentication application may comprise HTML data, images, icons, and/or executable code. The executable code may be composed in JavaScript, ECMAscript, coffeescript, python, Ruby or other programming languages suitable for execution within the client application, or translation into a client application executable form.

It will be apparent to one with ordinary skill in the art that, in certain embodiments, any of the functionality of the user nodes 301A-N, cloud services 303, the blockchain network 304, and the certificate issuer system 305 may be incorporated into the server 307, and vice versa. Likewise, any functionality of a client application may be incorporated into a browser-based client, and such embodiments are intended to be fully within the scope of the invention.

In one embodiment, communication between a certificate issuer and authentication application and a connected device or system may involve the use of a translation and/or serialization module. A serialization module can convert an object from an in-memory representation to a serialized representation suitable for transmission via HTTP or another transport mechanism. For example, the serialization module may convert data from a native Python, Ruby, or Java in-memory representation into a JSON string for communication over the client-to-server transport protocol.

Embodiments of the subject matter and the functional operations described in this specification can be implemented in one or more of the following: digital electronic circuitry; tangibly-embodied computer software or firmware; computer hardware, including the structures disclosed in this specification and their structural equivalents; and combinations thereof. Such embodiments can be implemented as one or more modules of computer program instructions encoded on a tangible non-transitory program carrier for execution by, or to control the operation of, data processing apparatus (i.e., one or more computer programs). Program instructions may be, alternatively or additionally, encoded on an artificially generated propagated signal (e.g., a machine-generated electrical, optical, or electromagnetic signal) that is generated to encode information for transmission to suitable receiver apparatus for execution by a data processing apparatus. And the computer storage medium can be one or more of: a machine-readable storage device, a machine-readable storage substrate, a random or serial access memory device, and combinations thereof.

As used herein, the term “data processing apparatus” comprises all kinds of apparatuses, devices, and machines for processing data, including but not limited to, a programmable processor, a computer, and/or multiple processors or computers. Exemplary apparatuses may include special purpose logic circuitry, such as a field programmable gate array (“FPGA”) and/or an application specific integrated circuit (“ASIC”). In addition to hardware, exemplary apparatuses may comprise code that creates an execution environment for the computer program (e.g., code that constitutes one or more of: processor firmware, a protocol stack, a database management system, an operating system, and a combination thereof).

The term “computer program” may also be referred to or described herein as a “program,” “software,” a “software application,” a “module,” a “software module,” a “script,” or simply as “code.” A computer program may be written in any form of programming language, including compiled or interpreted languages, or declarative or procedural languages, and it can be deployed in any form, including as a standalone program or as a module, component, subroutine, or other unit suitable for use in a computing environment. Such software may correspond to a file in a file system. A program can be stored in a portion of a file that holds other programs or data. For example, a program may include one or more scripts stored in a markup language document; in a single file dedicated to the program in question; or in multiple coordinated files (e.g., files that store one or more modules, sub programs, or portions of code). A computer program can be deployed and/or executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, such as but not limited to an FPGA and/or an ASIC.

Computers suitable for the execution of the one or more computer programs include, but are not limited to, general purpose microprocessors, special purpose microprocessors, and/or any other kind of central processing unit (“CPU”). Generally, CPU will receive instructions and data from a read only memory (“ROM”) and/or a RAM. The essential elements of a computer are a CPU for performing or executing instructions and one or more memory devices for storing instructions and data. Generally, a computer will also include, or be operatively coupled to receive data from or transfer data to, or both, one or more mass storage devices for storing data (e.g., magnetic, magneto optical disks, and/or optical disks). However, a computer need not have such devices. Moreover, a computer may be embedded in another device, such as but not limited to, a mobile telephone, a personal digital assistant (“PDA”), a mobile audio or video player, a game console, a Global Positioning System (“GPS”) receiver, or a portable storage device (e.g., a universal serial bus (“USB”) flash drive).

Computer readable media suitable for storing computer program instructions and data include all forms of nonvolatile memory, media and memory devices. For example, computer readable media may include one or more of the following: semiconductor memory devices, such as erasable programmable read-only memory (“EPROM”), electrically erasable programmable read-only memory (“EEPROM”) and/or and flash memory devices; magnetic disks, such as internal hard disks or removable disks; magneto optical disks; and/or CD ROM and DVD-ROM disks. The processor and the memory can be supplemented by, or incorporated in, special purpose logic circuitry.

To provide for interaction with a user, embodiments may be implemented on a computer having any type of display device for displaying information to a user. Exemplary display devices include, but are not limited to one or more of: projectors, cathode ray tube (“CRT”) monitors, liquid crystal displays (“LCD”), light-emitting diode (“LED”) monitors and/or organic light-emitting diode (“OLED”) monitors. The computer may further comprise one or more input devices by which the user can provide input to the computer. Input devices may comprise one or more of: keyboards, a pointing device (e.g., a mouse or a trackball). Input from the user can be received in any form, including acoustic, speech, or tactile input. Moreover, feedback may be provided to the user via any form of sensory feedback (e.g., visual feedback, auditory feedback, or tactile feedback). A computer can interact with a user by sending documents to and receiving documents from a device that is used by the user (e.g., by sending web pages to a web browser on a user's client device in response to requests received from the web browser).

Embodiments of the subject matter described in this specification can be implemented in a computing system that includes one or more of the following components: a backend component (e.g., a data server); a middleware component (e.g., an application server); a frontend component (e.g., a client computer having a graphical user interface (“GUI”) and/or a web browser through which a user can interact with an implementation of the subject matter described in this specification); and/or combinations thereof. The components of the system can be interconnected by any form or medium of digital data communication, such as but not limited to, a communication network. Non-limiting examples of communication networks include a local area network (“LAN”) and a wide area network (“WAN”), e.g., the Internet.

The computing system may include clients and/or servers. The client and server may be remote from each other and interact through a communication network. The relationship of client and server arises by virtue of computer programs running on the respective computers and having a client-server relationship to each other.

Various embodiments are described in this specification, with reference to the detailed description above, the accompanying drawings, and the claims. Numerous specific details are described to provide a thorough understanding of various embodiments. However, in certain instances, well-known or conventional details are not described in order to provide a concise discussion. The figures are not necessarily to scale, and some features may be exaggerated or minimized to show details of particular components. Therefore, specific structural and functional details disclosed herein are not to be interpreted as limiting, but merely as a basis for the claims and as a representative basis for teaching one skilled in the art to variously employ the embodiments.

The embodiments described and claimed herein and drawings are illustrative and are not to be construed as limiting the embodiments. The subject matter of this specification is not to be limited in scope by the specific examples, as these examples are intended as illustrations of several aspects of the embodiments. Any equivalent examples are intended to be within the scope of the specification. Indeed, various modifications of the disclosed embodiments in addition to those shown and described herein will become apparent to those skilled in the art, and such modifications are also intended to fall within the scope of the appended claims.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

All references including patents, patent applications and publications cited herein are incorporated herein by reference in their entirety and for all purposes to the same extent as if each individual publication or patent or patent application was specifically and individually indicated to be incorporated by reference in its entirety for all purposes.

What is claimed is:

1. A method of issuing a digital certificate comprising:
receiving, by a certificate issuer system, a digital certificate request from a user device associated with a user;
receiving, by the certificate issuer system, from the user device, permission to access user information associated with the user and stored in an identity provider system;
upon accessing the identity provider system, receiving, by the certificate issuer system, the user information from the identity provider system;
creating, by the certificate issuer system, a digital certificate associated with certificate information comprising: identity information selected from the user information, a unique public key, a location associated with a distributed ledger system, and checksum algorithm information specifying a checksum algorithm;
calculating, by the certificate issuer system, a checksum of the certificate information based on the checksum algorithm;
transmitting, by the certificate issuer system, authenticity information associated with the digital certificate to the location to thereby cause the authenticity information to be recorded on the distributed ledger system,
wherein the authenticity information comprises the checksum and the public key; and
transmitting, by the certificate issuer system, the digital certificate to the user device to thereby cause the digital certificate to be stored in a memory of the user device.

2. A method according to claim 1, wherein the digital certificate conforms to a X.509 digital certificate standard.

3. A method according to claim 1, wherein the location comprises a smart contract address.

4. A method according to claim 3, wherein the smart contract address is associated with the Ethereum blockchain.

5. A method according to claim 1, wherein the certificate information further comprises one or more of: a unique ID, an issuer name, and a validity period.

6. A method according to claim 1, wherein the checksum algorithm comprises a SHA-2 cryptographic hash function.

7. A method according to claim 1 further comprising:
deleting, by the certificate issuer system, the user information and checksum from the certificate issuer system after said transmitting the digital certificate to the user device.

8. An authentication method comprising:
receiving, by a user authentication system, certificate information associated with a digital certificate,
wherein the certificate information comprises: a unique public key and checksum algorithm information specifying a checksum algorithm;
retrieving, by the user authentication system, authenticity information associated with the digital certificate,
wherein the authenticity information is stored at a location associated with a distributed ledger system, and
wherein the authenticity information comprises the unique public key and a first checksum;
calculating, by the user authentication system, a second checksum of the certificate information based on the checksum algorithm;
determining, by the user authentication system, that the first checksum matches the second checksum; and
upon said determining that the first and second checksums match, generating, by the user authentication system, an authentication confirmation,
wherein the authentication confirmation is not generated when the first and second checksums do not match.

9. A method according to claim 8, wherein:
the certificate information is received from a cloud application; and
the method further comprises transmitting the generated authentication confirmation to the cloud application.

10. A method according to claim 9, wherein:
the certificate information is received from the cloud application when the cloud application receives the digital certificate from a user device associated with a user attempting to perform an action relating to the cloud application; and
said transmitting the generated authentication confirmation causes the cloud application to allow the user to perform the action.

11. A method according to claim 10, wherein the location comprises an address of a smart contract associated with the distributed ledger system.

12. A method according to claim 11, wherein the user authentication system comprises a decentralized application associated with the distributed ledger system.

13. A method according to claim 8, wherein the certificate information is received from a user device.

14. A method according to claim 13, further comprising:
receiving, by the user authentication system, from the user device, a request to perform an action relating to the user authentication system; and
upon said generating the authentication confirmation, allowing the user device to perform the action,
wherein the user device is not permitted to perform the action when the authentication confirmation is not generated.

15. A method according to claim 14, wherein the user authentication system comprises a cloud application.

16. A method according to claim 8, wherein the digital certificate conforms to a X.509 digital certificate standard.

17. A method according to claim 8, wherein the location comprises a smart contract address.

18. A method according to claim 17, wherein the smart contract address is associated with the Ethereum blockchain.

19. A method according to claim 8, wherein the checksum algorithm comprises a SHA-2 cryptographic hash function.

20. A method according to claim 8, wherein the certificate information further comprises one or more of: identity information, location information specifying the location, a unique ID, an issuer name, and a validity period.
